(19) United States
(12) Patent Application Publication
(10) Pub. No.: US 2007/0075195 A1
(43) Pub. Date: Apr. 5, 2007

(54) Flat panel display with reflective member

(75) Inventors: Yung-Hsiang Chen, Miao-Li (TW); Che-Min Huang, Miao-Li (TW); Meng-Tse Tsai, Miao-Li (TW); Ming-Chih Huang, Miao-Li (TW); Hsin Lu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/541,212

(22) Filed: Sep. 29, 2006

(30) Foreign Application Priority Data
Sep. 30, 2005 (TW) 94134292

(51) Int. Cl. F16M 11/00; F16M 13/00

(52) U.S. Cl. 248/157; 248/419

(57) ABSTRACT

An exemplary flat panel display (20) includes a supporting member (23), and a display panel (21) having a display surface (211), and a rear surface (210). The display panel is pivotably attached to the supporting member, and the rear surface of the display panel includes a reflective member.

### FIELD OF THE INVENTION

The present invention relates to flat panel displays, and more particularly to a flat panel display having a reflective member.

### BACKGROUND

Desktop computers play an important role in modern information technology nowadays. A desktop computer generally includes a host, and a display that functions as an interface between users and the host. Displays are commonly divided into either of two kinds: cathode ray tube (CRT) displays or flat panel displays. A flat panel display has certain advantages compared to a CRT display, including being light in weight and having a thin profile. A popular kind of flat panel display is the liquid crystal display (LCD), thus, the complete replacement of CRT displays by LCDs in the future is foreseeable.

Referring to FIGS. 7 and 8, a conventional flat panel display 10 includes a display panel 11 having a display surface 111 and an opposite rear surface 112, a pivot 122, a base part 13, and a brace 12. The brace 12 is pivotally attached to the pivot 122 at one end portion thereof, and fixed at the base part 13 at another end portion thereof. The display panel 11 is pivotably attached to the pivot 122. A viewing angle between the display panel 11 and the base part 13 can be adjusted by rotating the display panel 11 about the pivot 122. A power supply port (not shown) and a video signal port (not shown) are provided at the rear surface 112 of the display panel 11.

The flat panel display 10 does not comply with so-called human engineering design, and may be considered to be insufficiently ergonomic, because the viewing angle between the display panel 11 and the base part 13 can generally only be adjusted within a limited range. In addition, the flat panel display 10 does not have any other useful function besides displaying of images.

Accordingly, what is needed is a flat panel display configured to be able to provide a wide range of viewing angles and multi-function features.

### SUMMARY

An exemplary flat panel display includes a display panel having a display surface and a rear surface, and a supporting member. The display panel is pivotably attached to the supporting member, and the rear surface includes a reflective member.

The flat panel display includes power supply and video signal ports provided at the supporting member and each is connected to the display panel by power and video wires embed within the supporting member.

Unlike in the prior art, the display panel can rotate about the pivot widely and the rear surface defines a reflective member thereat providing multi-function purpose.

A detailed description of embodiments of the present invention is given below with reference to the accompanying drawings.

### BRIEF DESCRIPTION OF THE DRAWINGS

In the drawings, all the views are schematic.

FIG. 1 is an exploded, isometric front view of a flat panel display in accordance with a first embodiment of the present invention, the flat panel display including a rotatable display panel.

FIG. 2 is an isometric, back view of the flat panel display of FIG. 1 fully assembled.

FIG. 3 is an assembled view of the flat panel display shown in FIG. 1.

FIG. 4 is an exploded, isometric front view of a flat panel display in accordance with a second embodiment of the present invention, the flat panel display including a rotatable display panel.

FIG. 5 is an assembled view of the flat panel display shown in FIG. 4.

FIG. 6 is similar to FIG. 5, but showing the flat panel display after the display panel has been rotated 180°.

FIG. 7 is an isometric front view of a conventional flat panel display.

FIG. 8 is a side view of the flat panel display of FIG. 7.

### DETAILED DESCRIPTION OF PREFERRED EMBODIMENTS

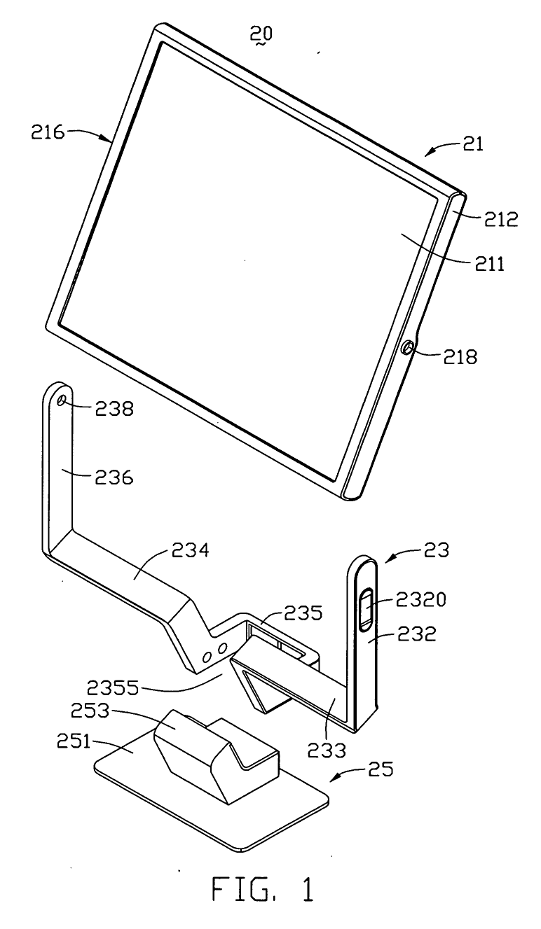

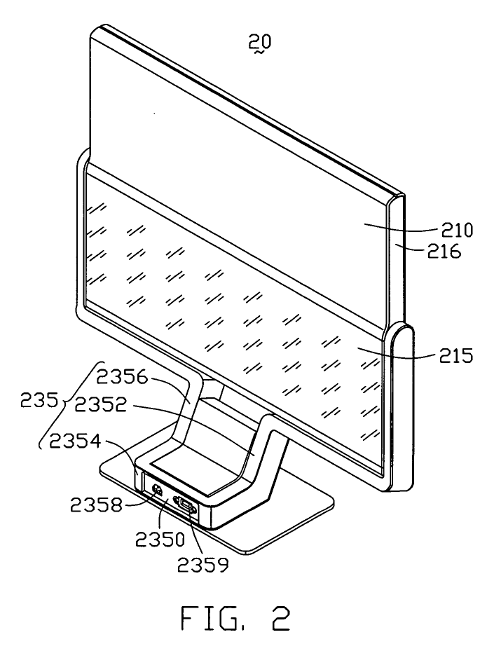

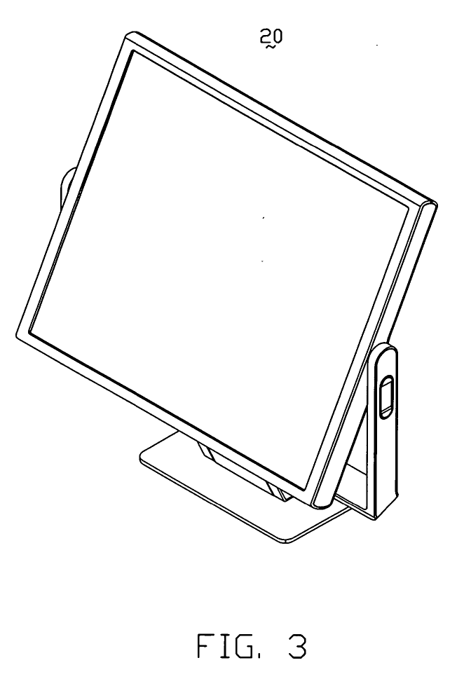

Referring to FIGS. 1 to 3, a flat panel display 20 in accordance with a first embodiment of the present invention includes a display panel 21, a supporting member 23, and a base member 25 having a base plate 251 and a protrusion part 253. The supporting member 23 is attached to the base member 25 at a central portion 235 thereof, and pivotably supports the display panel 21 at two top end portions thereof.

The display panel 21 includes a display surface 211, a rear surface 210 opposite to the display surface 211, and two opposite side surfaces 212, 216 adjacent to the display surface 211. When the display panel 21 is oriented vertically, the display, rear, and side surfaces 211, 210, 212, and 216 are all substantially perpendicular to the base plate 251 of the base member 25. The rear surface 210 is generally defined to be divided into upper and lower parts. A reflective member 215 is disposed at the lower part of the rear surface 210. The reflective member 215 has a mirrored surface. Each side surface 212, 216 include a pivot 218 extending perpendicularly therefrom. The pivot 218 has a hollow structure for allowing conductive wires to pass therethrough.

The supporting member 23 is a hollow structure, which can be formed integrally as a single body or formed by connecting several folded rectangular aluminum alloy pipes together. The supporting member 23 includes first and second braces 232, 236, first and second bending parts 233, 234, and a central portion 235. The first and second braces 232, 236 each define a blind hole 238 at a top end thereof, and the blind holes 238 are corresponding to the pivots 218 respectively. A diameter of each of the blind holes 238 is slightly larger than that of each of the pivots 218, so that the pivots 218 can be pivotably received in the blind holes 238 and rotates freely therein.

The first brace 232 includes a function button 2320 for adjusting characteristics of images displayed by the display panel 21 of the flat panel display 20. The function button 2320 is electrically connected to the display panel 21 by a conductive wire (not visible) located within the supporting member 23 and the proximal pivot 218, and the diameter of the pivot 218 at the side surface 212 is slightly larger than that of the pivot 218 at the side surface 216 allowing the conductive wire to pass therethrough, thereby providing the flat panel display 20 with a neat, attractive appearance.

The central portion 235 includes first, second, and third side walls 2352, 2354, and 2356 connected end-to-end, thereby cooperatively defining an open part 2355 therebetween. The first and third side walls 2352, 2356 each have a bent configuration, and are connected to the second and first bending parts 234, 233 respectively. The second side wall 2354 includes a recessed part 2350 having a power supply port 2358 and a video signal port 2359, which are connected to a circuit board (not visible) within the display panel 21 by a power wire (not visible) and a video wire (not visible) respectively. The power and video wires pass through the supporting member 23 and either or both of the pivots 218, thereby providing the flat panel display 20 with a neat, attractive appearance.

The base plate 251 and the protrusion part 253 can be formed integrally as a single piece, or can be two separate pieces that are attached together. The protrusion part 253 has a bent configuration matching that of the open part 2355 of the central portion 235. Thereby, the protrusion part 253 can be snugly received in the open part 2355 and tightly attached to inner sides of the first, second and third side walls 2352, 2354, and 2356. Bottom walls of the central portion 235 that are adjacent to the first, second and third side walls 2352, 2354, and 2356 can be tightly fixed to the base plate 251 by screws (not shown) or by other suitable fixing means.

The pivots 218 are pivotably engaged in the blind holes 238 of the supporting member 23 by pivotally attach the pivots 218 in the corresponding holes 238, whereby the display panel 21 is pivotably attached to the supporting member 23. That is, the display panel 21 is pivotally attached to the supporting member 23 by the pivots 218, thereby allowing the display panel 21 to rotate with the pivots 218 freely.

In various alternative embodiments, the function button 2320 can be located at the second brace 236. The recessed part 2350 can be formed at the first side wall 2356 or the third side wall 2352, in which case the power supply and video signal ports 2358, 2359 are provided at the first side wall 2356 or the third side wall 2352 accordingly. The pivots 218 can be provided at the first and second braces 232, 236, in which case the blind holes 238 are defined at the side surfaces 212, 216 at positions corresponding to the pivots 218 respectively. The reflective member 215 can be located at the upper part of the rear surface 210. Two or more reflective members 215 can be provided at any desired part or parts of the rear surface 210. The reflective member 215 can be replaced by a calendar, an electronic calculator, or any other desired article.

Unlike in the prior art, the display panel 21 of the flat panel display 20 can be freely rotated with the pivots 218. This enables adjustment of the display panel 21 over a very wide range of viewing angles, so that the flat panel display 20 complies with so-called human engineering design and can be considered to be highly ergonomic. In addition, the mirrored surface of the reflective member 215 at the rear surface 210 provides the flat panel display 20 with multi-functionality.

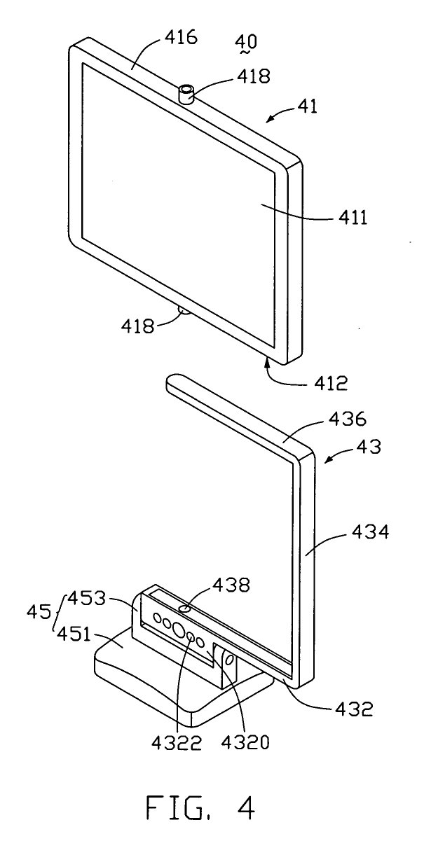

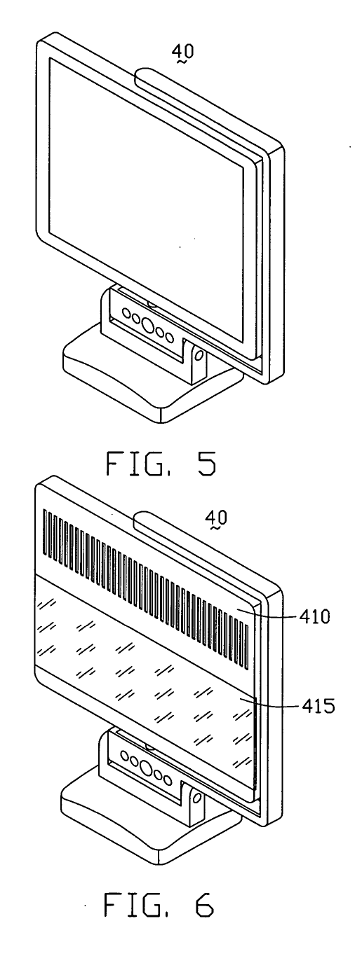

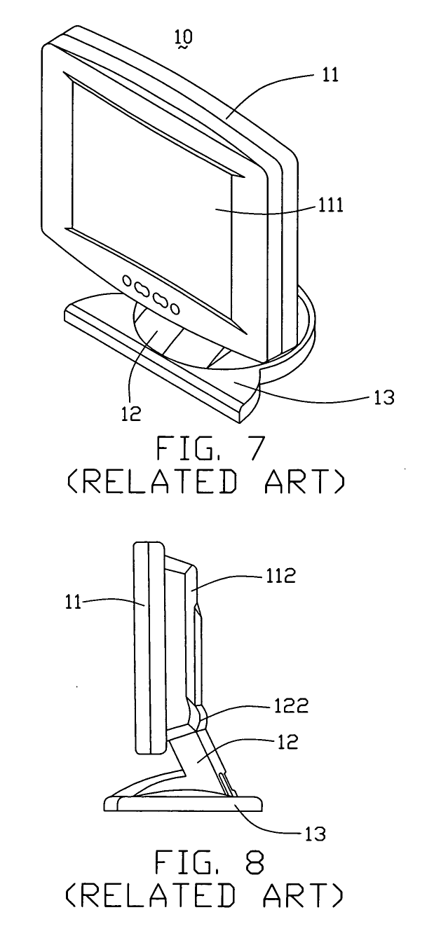

Referring to FIGS. 4 to 6, a flat panel display 40 according to a second embodiment of the present invention includes a display panel 41, a supporting member 43, and a base member 45 having a base plate 451 and a protrusion part 453. The supporting member 43 is fixed to the base member 45 at a central portion thereof, and pivotably supports the display panel 41 at top and bottom portions thereof.

The display panel 41 includes a display surface 411, a rear surface 410 opposite to the display surface 411, and a top surface 416 and a bottom surface 412 adjacent to the display surface 411. The display surface 411 and rear surface 410 are substantially perpendicular to the base plate 451 of the base member 45, and the top surface 416 and bottom surface 412 are substantially parallel to the base plate 451 of the base member 45. The rear surface 410 is generally defined to be divided into upper and lower parts. A reflective member 415 is disposed at the lower part of the rear surface 410. The reflective member 415 has a mirrored surface. The top surface 416 and bottom surface 412 each include a pivot 418 extending perpendicularly therefrom. Each pivot 218 has a hollow structure for allowing conductive wires to pass therethrough.

The supporting member 43 is a hollow structure, which can be formed integrally as a single body or formed by connecting several folded rectangular aluminum alloy pipes together. The supporting member 43 includes first, second and third braces 432, 434 and 436. The first and third braces 432, 436 each define a blind hole 438 at an end portion thereof, the blind holes 438 corresponding to the pivots 418 respectively. A diameter of each of the blind holes 438 is slightly larger than that of each of the pivots 418, so that the pivots 418 can be pivotably received in the blind holes 438 and rotates freely therein.

The first brace 432 includes a protruding part 4320, which has several function buttons 4322 for adjusting the characteristics of images displayed by the display panel 41 of the flat panel display 40. The function buttons 4322 are electrically connected to the display panel 41 by conductive wires (not visible) located within the first brace 432 and the proximal pivot 418, thereby providing the flat panel display 40 with a neat, attractive appearance.

The base plate 451 and the protrusion part 453 can be formed integrally as a single piece, or can be two separate pieces that are attached together. The protrusion part 453 is pivotably attached to the protruding part 4320 by a hinge (not labeled). Thereby, a viewing angle of the display panel 41 relative to the base member 45 is adjustable.

The base plate 451 includes a power supply port (not visible) and a video signal port (not visible), which are connected to a circuit board (not visible) within the display panel 41 by a power wire (not visible) and a video wire (not visible) respectively. The power and video wires are located within the hollow structure of the base member 45 and the supporting member 43, thereby providing the flat panel display 40 with a neat, attractive appearance.

The pivots 418 are pivotably engaged in the blind holes 438 of the supporting member 43 by pivotally attach the pivots 218 in the corresponding holes 238, whereby the display panel 41 is pivotably attached to the supporting member 43. That is, the display panel 41 can rotate with the pivots 418 freely.

Unlike in the prior art, the display panel 41 of the flat panel display 40 can be freely rotated with the pivots 418. This enables adjustment of the display panel 41 over a very wide range of viewing angles, so that the flat panel display 40 complies with so-called human engineering design and can be considered to be highly ergonomic. In addition, the mirrored surface of the reflective member 415 at the rear surface 410 provides the flat panel display 40 with multi-functionality.

In various alternative embodiments, the function buttons 4322 can be located at the second brace 434. The power supply port and video signal port can be provided at a rear side of the protruding part 4320. The pivots 418 can be provided at the first and third braces 432, 436 respectively, in which case the blind holes 438 are defined at the top surface 416 and bottom surface 412 at positions corresponding to the pivots 418 respectively. The reflective member 415 can be located at the upper part of the rear surface 410. Two or more reflective members 415 can be provided at any desired part or parts of the rear surface 410. The reflective member 415 can be replaced by a calendar, an electronic calculator, or any other desired article. The supporting member 43 can include only the first brace 432, and omit the second and third braces 434, 436. In such case, the bottom pivot 418 of the display panel 41 is pivotably attached to the first brace 432 in the blind hole 438 of the first brace 432. Alternatively, a pivot 418 of the first brace 432 is pivotably attached to the display panel 41 in a blind hole 438 of the display panel 41.

While various examples and embodiments have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A flat panel display, comprising:
a supporting member; and
a display panel having a display surface and a rear surface, wherein the display panel is pivotably attached to the supporting member, and the rear surface has a reflective member thereat.

2. The flat panel display as claimed in claim 1, wherein the reflective member has a mirrored surface.

3. The flat panel display as claimed in claim 2, further comprising a base member attached to the supporting member.

4. The flat panel display as claimed in claim 3, wherein the display panel further comprises two side surfaces, and each side surface has a pivot.

5. The flat panel display as claimed in claim 4, wherein the supporting member comprises two braces, each brace defines a hole, and the pivots are pivotably engaged in the holes respectively.

6. The flat panel display as claimed in claim 3, wherein the display panel further comprises two side surfaces, and each side surface defines a hole.

7. The flat panel display as claimed in claim 6, wherein the supporting member further comprises two braces, each brace comprises a pivot, and the pivots are pivotably engaged in the holes respectively.

8. The flat panel display as claimed in claim 3, wherein the display panel further comprises a top surface and a bottom surface.

9. The flat panel display as claimed in claim 8, wherein each of the top surface and the bottom surface has a pivot.

10. The flat panel display as claimed in claim 9, wherein the supporting member comprises two braces, each brace defines a hole, and the pivots are pivotably engaged in the holes respectively.

11. The flat panel display as claimed in claim 8, wherein each of the top surface and the bottom surface defines a hole.

12. The flat panel display as claimed in claim 11, wherein the supporting member comprises two braces, each brace has a pivot, and the pivots are pivotably engaged in the holes respectively.

13. The flat panel display as claimed in claim 8, wherein the bottom surface comprises a pivot.

14. The flat panel display as claimed in claim 13, wherein the supporting member comprises a brace having a hole, and the pivot is pivotally attached to the supporting member in the hole.

15. The flat panel display as claimed in claim 1, wherein the supporting member comprises a power supply port and a video signal port, and each of the power supply port and video signal port is electrically connected to the display panel by a power wire and a video wire respectively.

16. The flat panel display as claimed in claim 15, wherein the power wire and the video wire are inside the supporting member.

17. The flat panel display as claimed in claim 1, wherein a function button is provided at the supporting member, and is electrically connected to the display panel by a wire.

18. The flat panel display as claimed in claim 1, wherein the supporting member is made from aluminum alloy.

19. A flat panel display assembly comprising:
a U-shaped structure defining two opposite and parallel side arms, at least one of said side arms being equipped with a conductive element;
a display panel defining a pivotal axis through a horizontal middle line;
a side arms electrically and mechanically connected to the display panel via said pivotal axis.
